(19) United States
(12) Patent Application Publication
(10) Pub. No.: US 2005/0144061 A1
(43) Pub. Date: Jun. 30, 2005

(54) Method of and apparatus for forecasting the price of a commodity

(76) Inventors: Malcolm Edward Rarity, Surrey (GB); Adrian Marsh, Surrey (GB)

Correspondence Address: Richard C Woodbridge;Synnestvedt Lechner &Woodbridge, P O Box 592, Princeton, NJ, 08542-0592, US

(21) Appl. No.: 10/312,494

(22) PCT Filed: Apr. 24, 2002
(86) PCT No.: PCT/GB02/01911

(30) Foreign Application Priority Data
Apr. 26, 2001 (GB) 0110249.0

(51) Int. Cl. G06F 17/60

(52) U.S. Cl. 705/10

(57) ABSTRACT

A pricing engine that automatically forecasts a price of a tradable commodity so that a quote price can be generated that will remain valid for a pre-defined time window. The pre-defined time window is typically a short time interval which is long enough for the user to evaluate the price and trade on it if required. In one implementation, the pricing engine forecasts what the price is likely to be at the end of the pre-defined time window and that forecasted price is then used as the basis for the quote price.

### REMARKS

This application is a National Stage filing of PCT application PCT/GB02/01911 filed on Apr. 24, 2002. Claims 1-41 have been cancelled and replaced with claims 42-82 to remove the multiple dependencies and place the application in a more acceptable form for examination. The U.S. Patent Office is hereby requested to examine the application based upon the substitute specification and claims. If the patent examiner has any questions or comments, he is respectfully requested to contact applicant's attorney at the telephone number indicated below so that additional amendments may be added as required.

### FIELD OF THE INVENTION

This invention relates to a method of and apparatus for forecasting the price of a commodity. It finds application in pricing engines used to price tradable commodities.

### DESCRIPTION OF THE PRIOR ART

Network based transaction platforms are widely-used for trading a broad range of commodities at fluctuating prices. Conventional platforms quote two different kinds of prices: first, guide or indicative prices. These are approximate, non-legally binding and meant to give a rough idea of the price that would be available to trade at. If an end-user (sometimes referred to as a ‘party’ or a ‘client’) wishes to actually trade a commodity (i.e. buy or sell), then he will send a request for a quote (or ‘RFQ’) which fully defines the required trade (e.g. commodity, amount, tenor etc.) to the transaction platform provided by a bank or other kind of financial institution. The RFQ may pass through or be initiated by a portal. The RFQ will be sent for credit vetting (i.e. to ensure that the end-user has sufficient credit to conduct the trade) and then to a pricing or quoting engine to give a second kind of price—a firm and legally binding price. This price is sometimes called an ‘execution’ price, since an end-user can execute a trade at that price. This firm price is communicated to the end-user via the network and the end-user can either proceed with it (e.g. hit a ‘buy’ (or ‘sell’) key on their terminal) or ignore it. Proceeding constitutes an offer to trade made by the end-user; this offer is then sent to the transaction platform over the network. If the offer is received quickly enough, it may be accepted by the platform and the trade will then be carried out. But if the end-user has been too slow in responding, or if the ‘buy’ (or ‘sell’) message has been slowed down because of latency (e.g. inherent network latency or heavy congestion or any other process which slows down message process, such as credit checking) then it may reach the transaction platform after the price has changed; the transaction platform will then refuse to proceed further. This is especially frustrating to end-users trading over the public internet using web based transaction platforms at times of rapidly falling prices—end-users will place trades to sell at the price quoted at one instant, only for their sell order to be rejected because by the time it is received at the transaction platform, the price has altered. The same problem arises at times of rapidly rising prices.

A conventional auto-pricing engine determines price using a number of factors, including the identity of the end-user, the size of the transaction, its tenor, the applicable trader spread and salesperson spread. But conventional pricing engines calculate prices based on the most recent live data only: as explained above, at times of rapidly changing prices, this inevitably leads to new prices being automatically generated and supplied so quickly that an end-user does not have enough time to properly evaluate the price or even to capture a trade at a displayed price, since his order will be received by the transaction platform after that price has been replaced by a new price.

Two further examples will illustrate this problem. When an end-user wishes to trade on a web based portal which collects pricing data from several sources (e.g. FXall and Currenex for foreign exchange), the portal can operate a ‘fast quote’ system, in which it typically sends out a RFQ to e.g. 5 participating banks and then displays each of the 5 prices, updated in real time. Since each price may change every second or so (more rapidly still at times), the challenge facing an end-user is one of identifying and selecting the best deal almost instantly; this challenge is quite considerable, even for professional users. For less experienced end-users, particularly retail users or smaller corporate treasury departments (exactly the kinds of users who might most benefit from a web based FX trading system), the challenge is an extreme one.

The ‘reverse auction’ approach is meant to address this problem. In a reverse auction, the portal sends out a RFQ to e.g.5 participating banks if an end-user needs an execution price; each bank then has e.g. 25 seconds to release a price. That price is meant to be firm for e.g. 5 seconds, in order to give the end-user enough time to consider and trade at that price if he wishes. However, if a bank's price changes during this 5 second period, the quote auto-terminates. Hence, there is no guarantee to an end-user that any quote will in fact definitely be available to trade on for the full 5 seconds. Again, at times of fast moving prices, the likelihood is that the prices will not remain stable for 5 seconds, again denying end-users the ability to trade at critical times, such as market crashes.

The unreliability of legally binding execution prices has been considered above. But the unreliability of even indicative rates is problematic too since (a) it implies that execution prices will be similarly unreliable and (b) it gives the impression that the entire dealing process is opaque. This is particularly problematic for web based trading systems aimed at appealing to a wide base of end-users.

Reference may also be made to pricing models which predict future prices over a much longer time period of typically days or weeks. These kinds of pricing models are however of limited relevance to the present invention since they apply forecasting techniques to predict a specific price in the future to identify buying and selling opportunities. In contrast, the present invention addresses the particular problem of typically short-term price volatility which in the past has meant that prices can alter too rapidly to allow trades to be completed at a quoted price.

### SUMMARY OF THE PRESENT INVENTION

In a first aspect of the present invention, there is a pricing engine that automatically forecasts a price of a tradable commodity so that a quote price can be generated that will remain valid for a pre-defined time window. In one implementation, the pricing engine forecasts what the price is likely to be at the end of the pre-defined time window and that forecasted price is then used as the basis for the quote price. Volatility and non-volatility related spreads may be applied to the forecast price to generate an actual quote price.

The pre-defined time window is typically a short time interval which is long enough for the user to evaluate the price and trade on it if required As explained in the prior art section, auto-generated prices that are guaranteed to remain fixed for a given time period are not known: instead, prior art systems offer only prices which either fluctuate as live prices change (the ‘fast quote’ system) or else terminate when live prices change (the ‘reverse auction’ system). In a spot FX implementation, for example, a 10 second pre-defined time window may give a guaranteed stable 6 seconds ‘trading window’ at the end-user terminal, taking into account the time it takes a message to be sent from the pricing engine/transaction platform to the end-user and back again.

To date, no-one has appreciated the possibility of applying price forecasting techniques to allow a quote price to be automatically generated and remain valid (i.e. remain acceptable by a transaction platform) over a pre-defined time window long enough to allow a user to consider a trade and for that order to be received and accepted at the transaction platform. This has occurred despite the widespread criticism directed at many web based commodity trading systems because they failed to allow end-users to complete trades during turbulent price events (e.g. major corrections) and hence locked out users at the very time they were most anxious to trade.

A major barrier to even appreciating the possibility of auto-forecasting prices to give quotes a guaranteed, valid trading window of (typically) several seconds is that this is not a core skill practised by even expert currency traders. In theory, an expert currency trader might feel able to ‘intuit’ an appropriate price to quote a client if he knows that the client will take up to 10 seconds to respond because of network communications latencies etc, but in practice the expert trader is active on networks with minimal latency and would not be exposing him/herself to the additional risk undertaken when quoting a valid price over a slow connection. There is therefore no published theoretical understanding of the factors that might be applied by a trader in these circumstances, in part also because the skills of an expert trader are used for far more sophisticated tasks, such as reacting to macroeconomic trends (e.g. political events, company reports, analysts' reports etc), ‘reading’ the customer—e.g. moving a price down due to the trader's belief that the customer may be a seller, and ‘quoting against your position’—e.g. moving a price up to increase the likelihood that the customer may sell, in the event that the trader may wish to reduce a short position.

In contrast, the present invention forecasts price by monitoring the usually small price fluctuations caused by the rapid, transient changes in supply and demand for the purpose of enabling a price quote to be published to an end-user which can be guaranteed to remain valid for a pre-defined time which is selected to be long enough for the end-user to adequately consider and trade at that price. Equally important, is that the present invention allows for multiple quotes to be constantly (e.g. every 6 seconds a customer receives a new price valid for a further 6 seconds) given in multiple currencies over multiple tenors, simultaneously, to a bank's entire client base—a feat impossible to replicate with human resource alone.

In one implementation of the present invention, the pricing engine may apply a curve extrapolation algorithm to forecast the price, the algorithm using a weighted gradient formula to increase the significance of the rate of change of very recent prices compared to less recent prices.

The algorithm may be functionally equivalent to the following algorithm:

$${P}_{n + 1} = ( 1 / ( {2}^{n - 1} - 1 ) ) \times [ ( 3 \times {2}^{n - 2} - 1 ) {P}_{n} - ( {\sum }_{i = 1}^{n - 2} {2}^{n - i - 2} {P}_{n - 1} ) - {P}_{1} ]$$

where Pₙ₊₁ is the forecast price at time tₙ₊₁ as derived from an extrapolation of the changing live market prices P₁ . . . Pₙ measured at regular time intervals t₁ . . . tₙ.

In a spot FX implementation via a third-party portal, it has been found that forecasting 10 seconds into the future is suitable. That is because for some FX portals, the typical time it takes a message to be sent from the transaction platform to the portal and then on to the end-user terminal is approximately 2 seconds (with minimal latency between transaction platform and portal when operating over 128 kbps E1/T1 circuits) and the same amount of time is taken for the return path. Hence, the pricing engine is regularly forecasting a price 10 seconds in the future and the forecasted price is valid (i.e. forms the basis of a quote price that can be accepted) for the whole of that 10 seconds. A 10 second fixed time period gives an approximate 6 second ‘trading window’—i.e. a period of 6 seconds for the customer (via the portal) to actually decide whether to trade and to hit the buy (or sell) key. The price forecasting process is now repeated every 6 seconds, therefore ensuring that the customer (via the portal) has a price valid for 6 seconds, after which time the customer receives an updated price again valid for a further 6 seconds, and so on. It is also possible to monitor and compensate for substantial latency in the portal to end-user link—for example, if the network is a mobile communications network (e.g. 3G) then the latency may be significant. A longer fixed time period would be needed in these circumstances.

The preferred form of algorithm for FX spot tracks price changes from conventional real time FX price feeds and then defines a curve in which the interpolated historic price is taken at e.g. 6 second intervals, looking back e.g. 60 seconds in total. From this curve, the future price 6 seconds later is extrapolated. A progressive weighting is applied to the gradient (rate of change of price) between the price at each 6 second point, with each gradient given twice the weighting of the previous gradient (i.e. the gradient to the previous price point).

However, the most recent price gradient is more important than preceding price gradients and its weighting is tripled. Apart from the rate of change of the price, other measures may be relevant and useful parameters to model, such as speed of rate of change and curvature.

In an implementation for spot FX trading, an accuracy of over 99.4% has typically been achieved using 60 seconds of data to produce a 6 second trading window, meaning that only 5 quote prices in 1000 present any arbitrage opportunities during the 6 second period. Hence, the present invention allows quote prices to be guaranteed over a time window which is genuinely long enough to benefit end-users, without exposing the counterparty (i.e. bank etc.) to a significantly high risk of an adverse price movement making a trade unprofitable.

Because implementations of the present invention generate a short term price forecast (e.g. for the next 6 seconds in the case of spot FX via a web-site, or for the next 10 seconds via a third-party portal) using live pricing data obtained from market sources, significant macro-economic influences to prices are reflected in the incoming data anyway. The forecast price generated by the pricing engine will hence follow the general trends in the market. Further, volatility is constantly measured—e.g. the largest price differential (range) between regular time periods, such as every 6 seconds for the last 60 seconds, and this range is assumed to apply to the forecast price. Hence, if there is a significant event which causes the buy price of a commodity to rise sharply, the pricing engine will immediately notice and weight heavily the rate of price increase in the most recently measured 6 second period when calculating the forecast price, applying the appropriate range.

Other key features of implementations are:
An end-user's terminal displays a clock which shows the remaining time left for which the quote price will still be valid or the elapsed time for which the quote price has been valid.
The pricing engine increases the spread for longer pre-defined time windows to compensate for the decreased accuracy of the forecasted price and hence the increased risk incurred by a counterparty trading with an end-user at the quote price.
The pricing engine increases the spread for smaller amounts to be traded by an amount calculated to absorb transaction costs and deliver a profit on even ‘micro FX’ trades (e.g. USD50K worth or less)
Trader intervention to a spread that has been automatically calculated using the volatility apparent from the historic pricing data is readily achieved by allowing a scaling factor to be applied to the spread.

Other aspects of the present invention are:
A method of providing a quote price for a tradable commodity, in which the quote price (a) has been automatically generated using a forecast price calculated by a pricing engine and (b) remains valid for a pre-defined time window and (c) is supplied to an end-user over a network.
A computer terminal displaying a quote price of a tradable commodity, in which the quote price (a) is supplied over a network to the terminal and (b) is based on a forecasted price (automatically generated by a pricing engine) that will remain valid for a pre-defined time, and in which the terminal displays the remaining time for which a given quote price will remain valid and/or the elapsed time for which the quote price has remained valid.
A method of trading a commodity comprising the steps of:
   (i) viewing at an end-user terminal a quote price that (a) has been generated using a forecast price calculated by a pricing engine and (b) can be traded on so long as a trade order is received at a transaction platform during a pre-defined time window and
   (ii) placing an order at the quote price;
   (iii) receiving the order at a transaction platform within the pre-defined time window.
A system for trading commodities comprising (i) a pricing engine which forecasts a price of a tradable commodity so that a quote price can be generated that will remain valid for a pre-defined time window; (ii) end-user terminals that can display the quote price and allow end-users to place trades and (iii) a network interconnecting the pricing engine and the end-user terminals.
Quote price data that (a) has been generated using a forecast price calculated by a pricing engine and (b) remains valid for a pre-defined time window and (c) is supplied to an end-user over a network.

### BRIEF DESCRIPTION OF THE DRAWINGS

An implementation of the present invention will be described with reference to the accompanying drawings. The implementation is from ING Bank N.V. of London, United Kingdom and is called the PriceLock™ auto-pricing system. PriceLock™ is part of an electronic FX trading platform called the eFX™ system. The accompanying drawings show the following:

FIG. 1 is a high level architecture diagram of the eFX system;

FIG. 2 is a screen shot of the ‘Price Control Sheet’ window from a computer terminal used by a trader to monitor and manage the eFX system;

FIG. 3 is an eFX ‘Dealer Spread Sheet’ window;

FIG. 4 is a typical FX Spot dealer's screen, showing multiple eFX windows;

FIG. 5A is a graph showing how prices are measured and used to construct a forecast price with the PriceLock engine;

FIG. 5B is a timing diagram relating how regularly generated forecast prices relate to the trading windows displayed on a terminal using the PriceLock system;

FIG. 6 is an eFX ‘Market Sheet’ window, pre-populated with indicative FX prices;

FIG. 7 is an eFX ‘Order Capture’ window;

FIG. 8 is an eFX end-user/customer screen during a trade which has been sent to dealer intervention;

FIG. 9 shows a complete eFX trade history search for all users;

FIG. 10 shows an eFX Price Service Info Sheet, giving auto-pricing engine audit and analytics.

### DETAILED DESCRIPTION

The present invention will be described with reference to an implementation from ING Bank N.V. of London, United Kingdom called the PriceLock™ auto-pricing system. PriceLock™ is part of an electronic FX trading platform called the eFX™ system.

Business Overview

Financial institutions are moving business on-line. More efficient use of existing technology is granting those banks with automatic pricing engines a huge advantage in the field of foreign exchange. Recent experience of trading on the multi-bank portal Atriax had shown that customer requests for quote (RFQs) were being answered, transacted, and confirmed by proprietary auto-pricing engines in less time than it takes a human sales representative to even acknowledge the request. The proprietary ING eFX system incorporates the advanced PriceLock™ auto-pricing engine and the customer and dealer screens required for multiple internet/intranet price-making and price-taking.

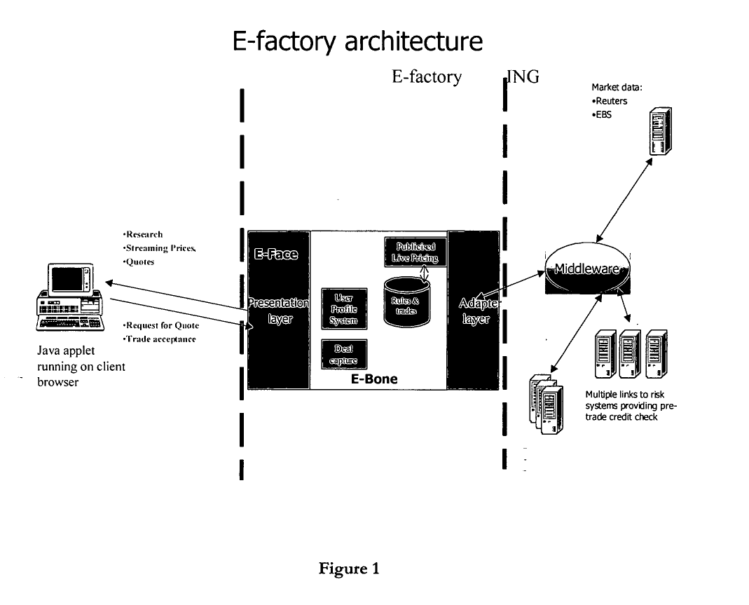

ING customers can trade FX on an ING web-site over the public internet, and on third party platforms via public internet and virtual private networks. Trades are automatically pre-checked for the existence of adequate counterparty limits, and delivered automatically into the deal-capture system, thus facilitating straight-through-processing. This system also turns ‘micro-FX’ into revenue, whereas before it represented a processing cost, and enables the efficient re-use of common IT components. FIG. 1 is a high level architecture diagram of the eFX system showing the core components. These include:
Request for quote (RFQ) flow from end user terminals to the presentation layer of the platform (the ‘E-factory’ portion in FIG. 1). This allows users to request dealable/executable prices for spot, forward, and matched swap transactions over the Internet. Clients use a java trading applet, which will download on client login.
PriceLock Pricing Engine (the ‘Publicised Live Pricing’ element). This provides dealable prices. In the case of spot and forward FX, these are generated using mathematical algorithms. The price engine will be used to stream live prices to the user as well as for pricing individual RFQs. Prices may be over-ridden by the ING trader.
Dealer Intervention (DI)—allows dealers to respond manually to a price request.
Trade Capture—on acceptance of a price, the completed trade will be passed through MQ to the ING deal capture system Valuta.
Pre-trade credit-checking facility utilising ING risk system RXM.

The solution also makes use of the following generic components provided by the eFactory infrastructure:
User Profiling system—facilitates user authorisation and personalisation.
Security—2 factor authentication (user/password and secure id).
Marketwatch—displays streaming live prices and research (latest and archive).

The eFX system design allows simultaneous publication of live prices in FX Spot, Forwards and Swaps to proprietary ING web-sites, third party web-sites, portals and exchanges. All trades are pre-checked for credit via an interface to an in-house counterparty risk system, and upon trade execution are immediately passed through to a Valuta front-office deal-capture and position-keeping system, providing a degree of straight-through-processing for all internet FX transactions. This will subsequently reduce middle office headcount requirements, allow more efficient use of front office resources, and reduce per-ticket transaction costs. The net effect is an increase in market-share through enhanced presence on an ING web-site and through professional multi-bank portals, and an additional increase in profitability from the realisation of revenue in ‘micro-FX’ transactions, which were previously not considered to be cost-effective.

Considerable market advantage is gained by auto-pricing on multi-bank portals, particularly with the proprietary PriceLock™ pricing engine which uses an innovative and unique methodology for producing a short-term forecasted rate, enabling the ING trader to guarantee the period of time for which the quoted price will be live or executable. The time period is configurable per currency, per tenor, and per client (some clients may have quicker connections than others e.g. portable phone vs. portal via leased line). Trading windows of guaranteed duration removes the frustration to the customer of prices changing too quickly for trades to be executed. This unique approach can be extended to other financial products.

The innovative PriceLock™ pricing engine approach of the present invention can be applied to any market where the following hold true:
1. An offer to buy or sell a commodity is made at one point in time t₀.
2. A resultant agreement to buy or sell that commodity is made at another distinct point in time t₁.
3. Varying supply and/or demand may or may not create price movement between times t₀ and t₁, e.g. as a result of change in retail markets and/or wholesale markets, and/or as a result of speculation.

The invention allows the user (e.g. bank offering the eFX system, as opposed to the end-user or customer) to produce a ‘forecast price’ at time t₀ which is valid until time t₁, where the interval between t₀ and t₁ is determined by the user, and where the user deploys a formula or several formulae to produce the ‘forecast price’.

It should be noted that, particularly with respect to internet or wireless trading between two parties, t₀ and t₁ must always be distinct points in time, and the time interval between them will be greater than or equal to the speed of connection over the applicable network.

Additionally, the PriceLock™ system provides the following optional benefits:
1 The ability for the user (including individual traders at the user) to vary the ‘spread’ (the difference between the commodity buying price and the selling price at time t₁) according to market volatility and/or the user's perception and/or expectation of market volatility.
2 The ability for the user to define any mathematical algorithm deployed in the production of the ‘forecast price’, e.g. for the purpose of analysing and/or monitoring the risk associated with the ‘forecast price’.
3 The ability for the user to refine any mathematical algorithm deployed in the production of the ‘forecast price’, e.g. for the purpose of aligning the risk associated with the ‘forecast price’ with the user's risk parameters.

Markets where the invention could reasonably be applied include Financial Markets, where market forces may create price movement as described, e.g. Fixed Income, Foreign Exchange, Equities, Commodities, Futures, Options and Derivatives.

The invention could also be applied to the energy markets, where the ability to forecast, for example, short-term electricity usage could lead to change in billing structure (e.g. not just ‘economy time’ but half-hourly, or shorter, price changes). The invention could also be applied to the telecommunications market, where the ability to forecast, for example, short-term mobile phone usage could lead to a change in billing structure (e.g. not just ‘off-peak’ but half-hourly, or shorter, price changes).

The PriceLock™ pricing engine provides a continuous series of 2 way process where spread can be dependent upon market volatility and where dealer defined parameters control pricing, trading and position risk.

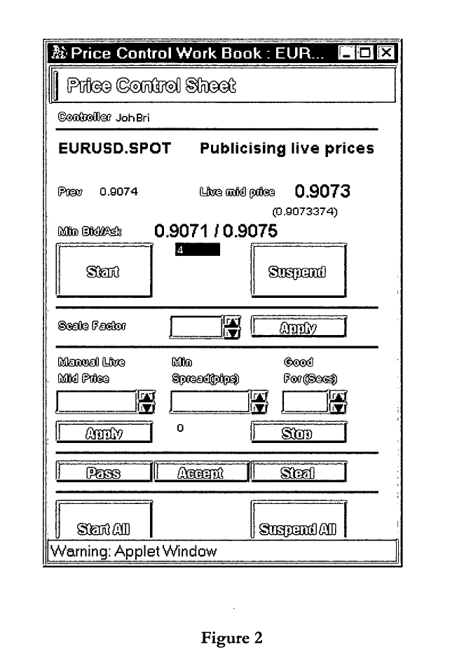

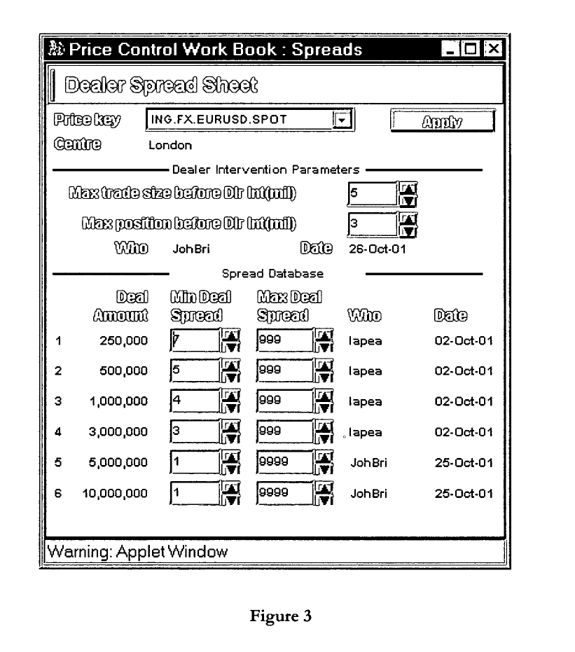

The eFX system design allows the FX dealer to overview and control the current published price whilst monitoring the aggregate position and average rate. FIG. 2 is a screen shot showing the window within a conventional web browser that is used by a trader to supervise and control the PriceLock™ quote prices supplied to end-users, in this case for spot Euro/USD trades. The window includes a ‘time remaining’ clock, here showing that a 4 second trading window still remains before the next price forecast occurs. The minimum bid price is 0.9071 and ask price is 0.9075; these are the indicative rates generated by the PriceLock™ pricing engine and which are held stable for 6 seconds at the end-users' terminals. Various control functions are also apparent and will be discussed later. The FIG. 2 screen also shows the current live mid-price being fed to the pricing engine—here 0.9073. Different scale factors can be selected and applied by the dealer using the ‘scale factor’ control. Dealers can over-ride the auto-pricing engine, configure their risk parameters and build a personalised spread database, as shown in FIG. 3.

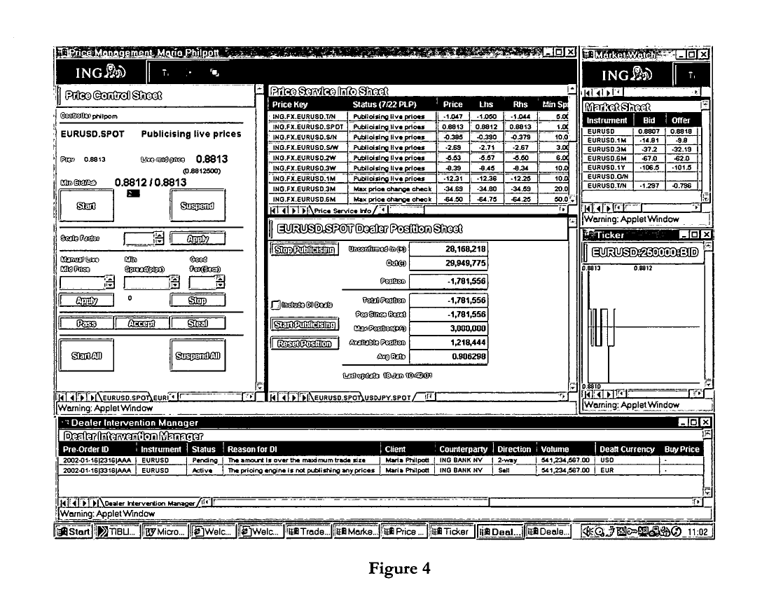

The screen of a typical FX spot trader at the user (i.e. not an end-user/customer) is shown at FIG. 4. Features offered include:
Pricing engine data
Price audit
Price warning
Manual over-ride
Volatility factoring
‘Panic’ buttons
Book passing
Position screen
Position warning
Dealer intervention
Market sheet
Charting tool

Price information and position responsibility is passed between active centers on a rotation basis since no center has 24 hour presence.

The PriceLock™ Pricing Engine Itself

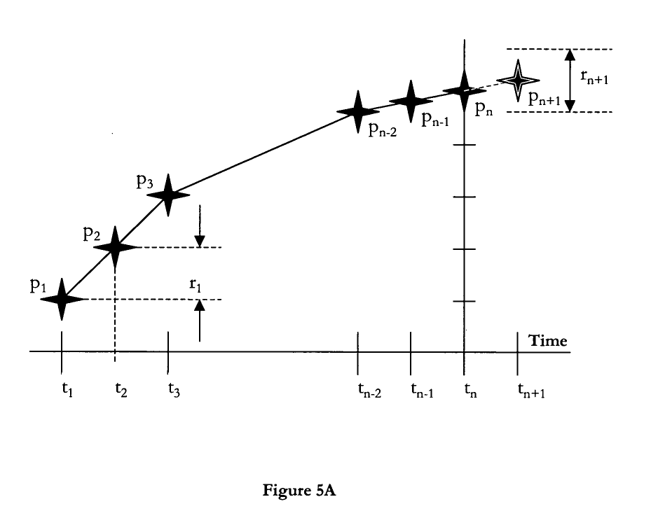

The PriceLock™ pricing engine:
Receives a continually updated record of live market prices from conventional sources, such as Reuters and EBS, so that whenever a market price changes, the new price is recorded;
Determines the mid-price (p₁ . . . pₙ) of the live market prices at regular intervals (t₁ . . . tₙ) and the range traded in each period (r₁ . . . rₙ), as shown in FIG. 5A. In the spot FX implementation, the engine takes a total of 60 seconds of data, splitting it up into 10 segments, noting the bid/offer prices at the beginning and end of each segment, and then calculating the mid-price at each 10 second interval. The engine then generates a 10 point mid-price curve, which is fed into the forecasting algorithm to generate the forecast price which is valid for the next 10 seconds, as explained for the general case of n intervals (as opposed to 6 intervals) below. The pricing engine could also forecast bid prices from recent bid prices and forecasts offer prices from recent offer prices, to give a 2 way price.
Calculates a forecast quote price based upon a number (n) of regular time intervals such that:

$${P}_{n + 1} = ( 1 / ( {2}^{n - 1} - 1 ) ) \times [ ( 3 \times {2}^{n - 2} - 1 ) {P}_{n} - ( {\sum }_{i = 1}^{n - 2} {2}^{n - i - 2} {P}_{n - 1} ) - {P}_{1} ]$$

where Pₙ₊₁ is the forecast price at time tₙ₊₁ as derived from an extrapolation of the changing live market prices P₁ . . . Pₙ measured at regular time intervals t₁ . . . tₙ.

The forecast price which is calculated expires at the end of the time period (commencing tₙ₊₁), at which point the pricing engine is updated with a live market price and a new forecast price is calculated. The system may also be configured, as is the case for third-party portals, to produce a forecast price good for t+(2×l) seconds (where l equals latency) using market data divided into equal (t+2l) time segments, but where the next price is forecast using historical data starting from only t seconds later (not t+2l). However the process will still be using a (t+21) time interval to forecast a price good for (t+2l) seconds. This ensures that the customer receives prices valid for t seconds, updating every t seconds. FIG. 5B shows a timing diagram illustrating how at t=60 seconds, forecasting can begin since enough historic data has been collected in the previous minute. Forecasting is repeated every 6 seconds (t=6 seconds, 12, 18 etc). Assuming a latency to the end-user of 2 seconds l=2) the first trading window is displayed between t=62-68; the second between t=68-74 and the third between t=74-80 etc. The ‘l’ factor can be different for every portal and indeed customer. For in-house systems using high bandwidth connections, ‘l’ can in fact be zero. The eFX forecasting tool's 6 second trading window is configurable per instrument (e.g. Euro/USD 1 month swap price is observed over 10×30 second time segments with the forecast price valid for 30 seconds), and may also be configured per customer.

The optimal forecasting formula typically depends on the price volatility characteristics of the particular commodity. Hence, one formula may be optimal for predicting foreign exchange price movements during the two to 10 seconds typical short time interval. The present intention can be applied to any volatile, price driven commodity, including without limitation stocks, shares, bonds and fixed income products.

The volatility based spread for this forecast price (rₙ₊₁) is estimated based on the highest range traded (r₁ . . . rₙ) over n intervals. This spread is placed around the forecasted mid-price. In the spot FX implementation, the maximum range recorded in the 10 segments of 6 seconds each is used, since this has been found to be a very good indication of short-term price volatility. It results in a PriceLock™ forecasting accuracy of over 99.4% for G7 currencies, which is far higher than might reasonably be expected. Accuracy is simply the number of circumstances where there was no price risk experienced, measured as a percentage of the number of calculated prices. A price risk is defined as an instant (typically fractions of a second) where the eFX bid is above the market offer or the eFX offer is below the market bid, i.e. an arbitrage opportunity.

In case traders might feel the automatically generated maximum range is inappropriate, the eFX system also includes the ability to ‘scale’ the spread (i.e. applying a factor to it, such as 25%, 50%, 120% etc.). This might occur if the auto-generated spread is too narrow (i.e. recent price volatility is very low). Trading with the auto-generated spread may mean that trading risk is virtually eliminated, but equally trading volumes and hence profit might also be very low, so that a trader might wish to increase the spread to increase transaction volumes and hence potential profits.

Additionally, traders may dictate a minimum or a maximum spread to be applied to the price, dependent upon the instrument and/or amount and/or tenor of the trade (see FIG. 3). The scaled spread is checked against these maxima and minima for consistency. Traders can also define ‘cruise control’ limits on an accumulated position, and maximum auto-quote amounts (again see FIG. 3).

A non-volatility-based spread is also applied by the eFX system; this is a pre-defined spread and takes into account the dealer and salesperson margins.

Traders are also given the option of manually over-riding the forecasted price with their own price, valid for their own time period (e.g. ‘manual live mid-price’ window in the FIG. 2 Control Sheet window).

The pricing engine is located at single server and control for any given dealer's book can be passed between different dealers across one or more countries, allowing fully automatic deal-capture (see the ‘pass’ button on the dealer Price Control Sheet window, FIG. 2). Trades are pre-checked for credit. Any breach of any trader parameters or credit limits automatically route a customer request for quote (RFQ) to dealer intervention.

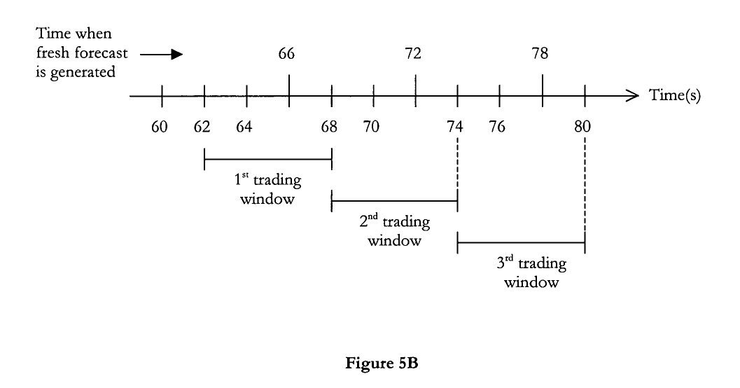

The PriceLock™ system can be used to supply indicative prices which are far more stable than conventional indicative rates—e.g. a guaranteed 6 second window during which the rate will not change, unlike conventional systems with prices that can change every second or yet more frequently, depending on market price movements. The indicative quote price is regularly re-generated (as shown in FIG. 5B) so that a fresh quote price is displayed to an end user once the previous quote price sent to that end-user has expired at the end of the 6 second window. The fresh quote price is sent prior to the end of a trading window by an amount of time calculated so that the fresh quote price terminates the preceding quote price at approximately the time it would self-terminate. FIG. 6 shows a ‘Market Sheet’ listing indicative rates of various currency pairs. The bid/offer price remains stable for 6 second periods.

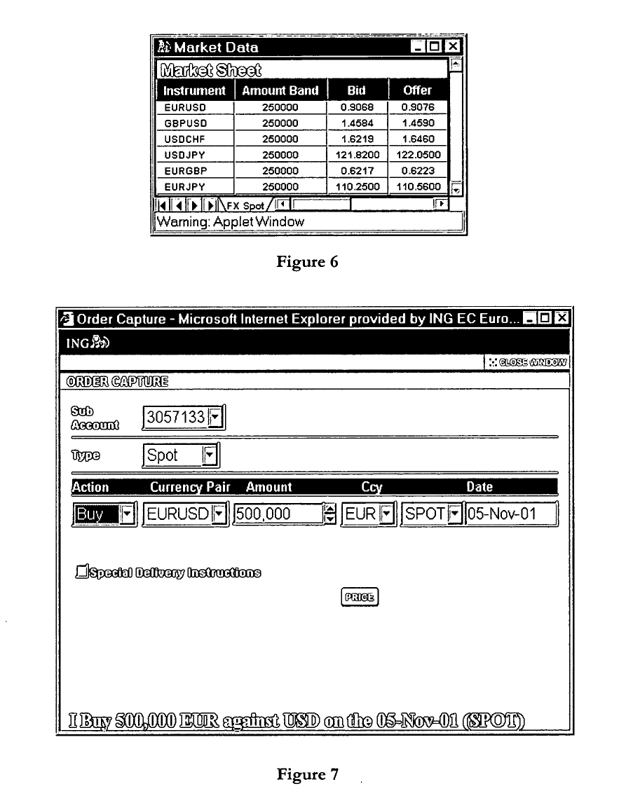

The PriceLock™ system can also be used to supply execution rates in both fast quote and reverse auction systems. If an end-user, viewing the FIG. 6 ‘Market Sheet’, wishes to trade a particular currency, then he selects the desired currency (e.g. by clicking the instrument or bid/offer columns in the Market Sheet window). Then, an ‘Order Capture’ window, at FIG. 7, is displayed. The end-user enters the appropriate details and selects the ‘price’ button.

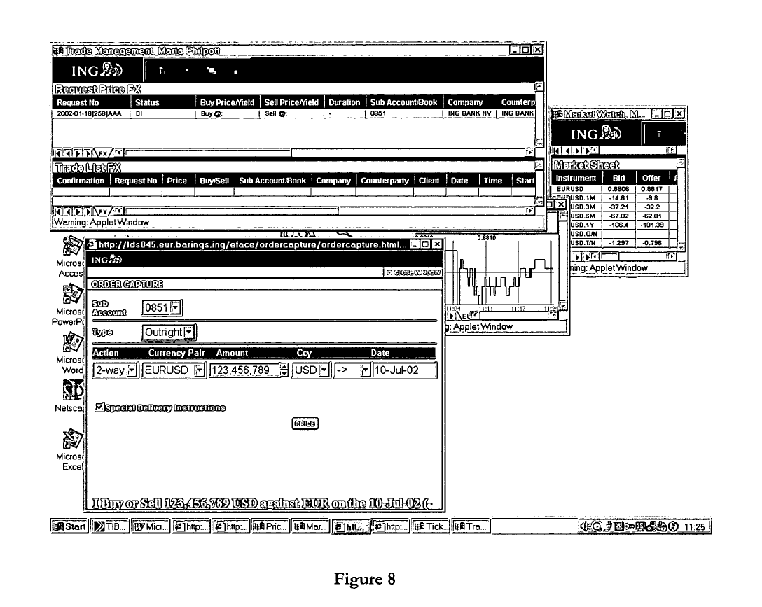

FIG. 8 shows the end-user/customer screen after a ‘price’ button has been selected to initiate a RFQ. In this particular example, a RFQ for a large trade has been input and this has breached the Dealer Parameters, or Risk Limits, and has been sent to manual Dealer Intervention.

The Request Price window indicates to the end-user/customer the status and normally also the remaining duration of the quote—i.e. the trading window. In this case, the duration field is blank because dealer intervention has been initiated, but normally the field content would count down from 6 seconds to 0 seconds, giving the user a clear indication of the time remaining to trade at the fixed price. Windows are re-sizeable and columns are interchangeable.

In a reverse auction system (as explained earlier) a bank is asked to supply a price in 25 seconds time from a start time T₀, with the price being displayed for 5 seconds. The eFX system supplies a quote price at approximately 24.5 seconds from T₀), assuming 0.5 s latency between the system and the requesting portal and zero latency to the end-user, forecasting the price 6 seconds into the future and hence giving the required 5 second guaranteed trading window when latency is taken into account. Depending upon the functionality offered by the third-party portal, the end-user's terminal may display a clock which shows the remaining time left during which the end-user may trade. In the case of the end-user transacting directly via ING's web-site(s) the end-user's terminal displays a clock in the form of a countdown bar which shows the remaining time left in which the end user can trade at the quote price or the elapsed time for which the quote price remains fixed.

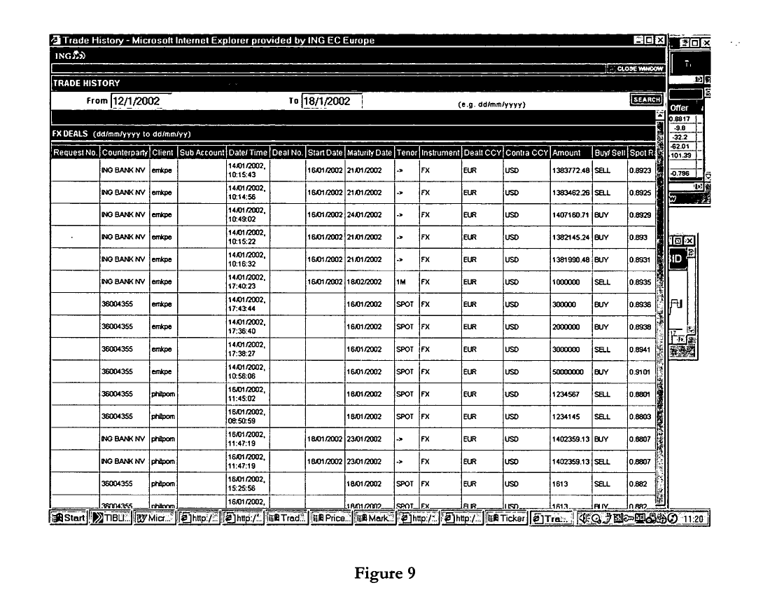

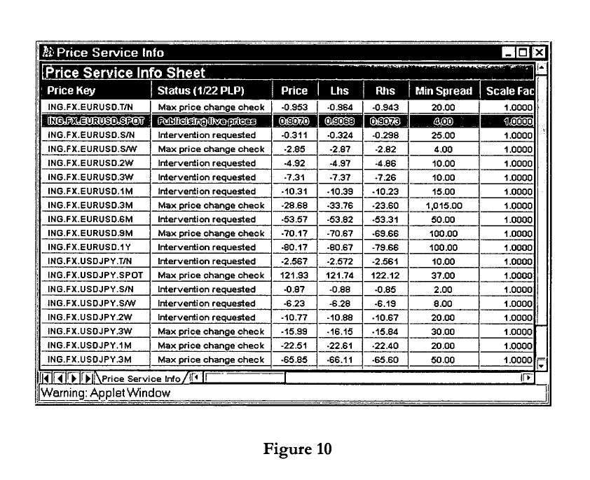

The eFX system also offers a complete trade history search for all end-users (as shown in FIG. 9) and audit and analysis data as shown in FIG. 10.

1-42. (canceled)

42. A pricing engine that automatically forecasts a price of a tradable commodity so that a quote price can be generated that will remain valid for a pre-defined time window.

43. The pricing engine of claim 42 which forecasts what the price is likely to be at the end of the pre-defined time window and that forecasted price is then used as the basis for the quote price.

44. The pricing engine of claim 42 which forecasts a mid-price from recent mid-prices, which define the mid-point between buy/sell prices.

45. The pricing engine of claim 42 which forecasts bid prices from recent bid prices and forecasts offer prices from recent offer prices, to give a 2 way price.

46. The pricing engine of claim 42 in which the quote price is sent in response to a request for a quote and is executable so that a user can trade on that price during a trading window of duration less than or equal to the pre-defined time window.

47. The pricing engine of claim 42 in which the quote price is not sent in response to a request for a quote from an end-user but is automatically generated, indicative only and not executable.

48. The pricing engine of claim 42 in which the quote price is determined using one or more of the following factors: recent prices, volatility/range of recent prices, deal size, tenor, party credit, scaling factor, tender spread, salesperson spread, network latency.

49. The pricing engine of claim 42 which applies a curve extrapolation algorithm to forecast the price, the algorithm using a weighted gradient formula to increase the significance of the rate of change of very recent prices compared to less recent prices.

50. The pricing engine of claim 49 which operates an algorithm which is functionally equivalent to the following algorithm:
$${P}_{n + 1} = ( 1 / ( {2}^{n - 1} - 1 ) ) \times [ ( 3 \times {2}^{n - 2} - 1 ) {P}_{n} - ( {\sum }_{i = 1}^{n - 2} {2}^{n - i - 2} {P}_{n - 1} ) - {P}_{1} ]$$
where Pₙ₊₁ is the forecast price at time tₙ₊₁ as derived from an extrapolation of the changing live market prices P₁ . . . Pₙ measured at regular time intervals t₁ . . . tₙ.

51. The pricing engine of claim 44 which applies the widest price range to the forecasted mid-price to generate a spread between buy/sell prices.

52. The pricing engine of claim 51 in which the spread generated around the forecasted mid-price is modifiable by a scaling factor which can be applied by a dealer wishing to apply a correction.

53. The pricing engine of claim 42 in which a scaling factor and/or any other kinds of spreads, corrections or other modifiers are applied to the forecast price by elements within a transaction platform that are outside of the pricing engine itself.

54. The pricing engine of claim 42 in which the pre-defined time window is calculated to be sufficient to result in a trading window at an end-user terminal that is long enough for the end-user to consider the quote price and successfully trade at that quote price, taking into account network related latencies.

55. The pricing engine of claim 54 in which the trading window is less than the pre-defined time window by an amount equal to the likely time it takes to send the quote price from a transaction platform to an end user terminal and to receive back an order from that terminal.

56. The pricing engine of claim 42 in which the duration of a pre-defined time window depends on the commodity being traded.

57. The pricing engine of claim 42 in which the duration of a pre-defined time window for a given end-user depends on the expected or monitored network latencies experienced by that end-user.

58. The pricing engine of claim 42 in which the duration of a pre-defined time window is 10 seconds or less for spot foreign exchange trades.

59. The pricing engine of claim 58 in which the duration of a pre-defined time window for spot foreign exchange trading is calculated to be long enough, taking into account likely network latencies, to give an end-user an approximately 6 second trade window in which to place an order.

60. The pricing engine of claim 42 in which the duration of the predefined time window depends on the stability of historic prices, such that relatively stable commodities such as FX swaps have an associated time window as long as 10 minutes and even stabler commodities such as Euro deposit rates have a time window as long as 1 day.

61. The pricing engine of claim 42 which generates price forecast data in conjunction with, or for use with timing data, the timing data enabling an end-user to be shown a clock which shows the remaining time left in which the end user can trade at the quote price or the elapsed time for which the quote price remains fixed.

62. The pricing engine of claim 42 in which the quote price is time stamped by a transaction platform, with the timing data being added either by the pricing engine itself or a timer situated externally to the pricing engine.

63. The pricing engine of claim 62 in which time stamping of quote prices enables the remaining duration of a quote price or the exact time of expiry of the quote price to be displayed on an end-user terminal using a real time clock

64. The pricing engine of claim 62 in which the transaction platform accompanies a quote price data with the duration of the pre-defined time window and/or trading window.

65. The pricing engine of claim 42 adapted to apply a spread to the forecast price, and to increase the spread for longer pre-defined time windows to compensate for the decreased accuracy of the forecasted price and hence the increased risk incurred by a counterparty trading with an end-user at the quote price.

66. The pricing engine of claim 42 adapted to apply a spread to the forecast price, and to increase the spread for smaller trade quantities by an amount calculated to absorb transaction costs and deliver a profit on the trade.

67. The pricing engine of claim 42 in which the quote price is regularly re-generated so that a fresh quote price is displayed to an end user once the previous quote price sent to that end-user has expired at the end of a trading window.

68. The pricing engine of claim 67 in which the fresh quote price is sent prior to the end of a trading window by an amount of time calculated so that the trading window of the fresh quote price terminates the trading window of the preceding quote price at approximately the time it would self-terminate.

69. The pricing engine of claim 42 in which the risk which the entity providing the quote price wishes to incur determines one or more of the following: the duration of the quote price window, the spread applied to the forecast price.

70. The pricing engine of claim 42, which is located at single server and control for any given dealer's book can be passed between different dealers across one or more countries.

71. A method of providing a quote price for a tradable commodity, in which the quote price (a) has been automatically generated using a forecast price calculated by a pricing engine and (b) remains valid for a pre-defined time window and (c) is supplied to an end-user over a network.

72. The method of claim 71 in which a web portal requests a quote from the pricing engine and displays the executable price to an end-user running a web browser.

73. The method of claim 72 in which the web portal is a FX portal.

74. The method of claim 71 in which the pricing engine is a pricing engine as defined in claim 42.

75. A computer terminal displaying a quote price of a tradable commodity, in which the quote price (a) is supplied over a network to the terminal and (b) is based on a forecasted price (automatically generated by a pricing engine) that will remain valid for a pre-defined time, and in which the terminal displays the remaining time for which a given quote price will remain valid and/or the elapsed time for which the quote price has remained valid.

76. The computer terminal of claim 75 in which the pricing engine is a pricing engine as defined in claim 42.

77. A method of trading a commodity comprising the steps of:
(i) viewing at an end-user terminal a quote price that (a) has been generated using a forecast price calculated by a pricing engine and (b) can be traded on so long as a trade order is received at a transaction platform during a pre-defined time window and
(ii) placing an order at the quote price;
(iii) receiving the order at a transaction platform within the pre-defined time window.

78. The method of claim 77 in which the pricing engine is a pricing engine as defined in claim 42.

79. A system for trading commodities comprising (i) a pricing engine which forecasts a price of a tradable commodity so that a quote price can be generated that will remain valid for a pre-defined time window; (ii) end-user terminals that can display the quote price and allow end-users to place trades and (iii) a network interconnecting the pricing engine and the end-user terminals.

80. The system of claim 79 in which the pricing engine is a pricing engine as defined in claim 42.

81. Quote price data that (a) has been generated using a forecast price calculated by a pricing engine and (b) remains valid for a pre-defined time window and (c) is supplied to an end-user over a network.

82. The quote price data of claim 81 generated from forecast data by a pricing engine as defined in claim 42.
